(19) United States
(12) Patent Application Publication
(10) Pub. No.: US 2025/0299656 A1
(43) Pub. Date: Sep. 25, 2025

(54) Automated Audio Data Extraction and Mixing

(71) Applicant: Hook Media, Inc., New York, NY (US)

(72) Inventors: Srivatsav Pyda, New York, NY (US); Gaurav Sharma, New York, NY (US)

(21) Appl. No.: 19/086,552

(22) Filed: Mar. 21, 2025

Related U.S. Application Data
(60) Provisional application No. 63/568,357, filed on Mar. 21, 2024.

(51) Int. Cl. G10H 1/00

(52) U.S. Cl. CPC G10H 1/0025; G10H 2210/076; G10H 2210/081; G10H 2210/105; G10H 2210/125; G10H 2210/576; G10H 2220/101; G10H 2240/075

(57) ABSTRACT

A system identifies a song structure by using beat markings and chord strings. The process includes steps of extracting of raw features using machine learning, creating beat markings and chord strings, and receiving mashup search details. The process iteratively analyses all songs in a catalog based on tempo, key, beat markings, chord strings, and creates a mashup using specific conditions. In case no matches are found, the process attempts to pitch-shift songs. This system facilitates automatic matching of songs enhancing rhythmic interplay and harmonic cohesion. It provides a systematic, granular examination of song structures, enabling accurate, efficient music matching and permitting the creation of high-quality mashups.

### CROSS-REFERENCE TO RELATED APPLICATION

This application claims the benefit of U.S. Provisional Application Ser. No. 63/568,357, filed Mar. 21, 2024, the entire content of which is incorporated by reference herein.

### TECHNICAL FIELD

This disclosure pertains to automated audio data extraction and mixing, and more specifically to identification and synchronization of musical features to create seamless song mashups.

### BACKGROUND

Creating audio mashups has historically presented several technical challenges that have hindered the seamless integration of multiple songs. One significant problem is the accurate extraction of musical features such as tempo, key, chord, beat/downbeat, and song structure. Traditional methods often rely on manual annotation or simplistic algorithms that fail to capture the intricate details of a song's harmonic and rhythmic elements. This can lead to mismatches in chords and beats, resulting in disjointed and unharmonious mashups.

Another challenge is the identification and synchronization of beats and sections within songs. Many existing systems struggle to accurately detect and align beats, bars, and sections, especially when dealing with complex song structures that vary in granularity. This misalignment can cause the mashup to sound off-beat or rhythmically inconsistent, detracting from the overall listening experience.

Additionally, the harmonic matching of chords poses a significant obstacle. Ensuring that the chords from different songs are compatible and harmonically cohesive requires sophisticated algorithms and extensive musical knowledge. Without proper chord matching, mashups can sound discordant and unpleasant, failing to achieve the desired musical blend.

To overcome these problems, conventional systems rely on computationally intensive processes that require large amounts of data and processing power to identify mashup matches that are compatible, harmonically cohesive, and that sound on-beat. It is desirable to have a computationally less resource intensive process.

### SUMMARY

In some embodiments, a computer-implemented configuration includes a system, method, and/or non-transitory computer readable storage medium comprised of stored instructions. The configuration includes receiving, via a graphical user interface (GUI) presented on a user computing device, a selection of an audio snippet, the selection indicating an identifier of an audio file, a start time, and an end time, wherein the audio file is from among a plurality of audio files in a mashup catalog. The configuration further includes accessing a beat marking associated with the audio file, the beat marking indicating metrical information associated with the audio file, the metrical information including for each of a plurality of beats of the audio file, a beat number, a bar number, and a section number. The configuration further includes accessing a chord string associated with the audio file, the chord string indicating harmonic information associated with the audio file, the harmonic information including a chord type for each of the plurality of beats of the audio file.

In some embodiments, the configuration further includes identifying a metrical signature and a chord string of the audio snippet, the metrical signature including a beat number and a bar number associated with a beat of the audio file corresponding to the start time, and the chord string including the chord type for each beat of the audio snippet. Still further, the configuration includes identifying, from among the plurality of audio files, a plurality of mashup candidate audio snippets that match the metrical signature of the audio snippet and that have a beat length that matches a beat length of the audio snippet. Yet still further, the configuration includes comparing the chord string of the audio snippet with respective chord strings of each of the plurality of mashup candidate audio snippets to identify a subset of the plurality of mashup candidate audio snippets that harmonically match the audio snippet. And still further, the configuration further includes receiving, via the GUI presented on the user computing device, a selection of one of the subset of the plurality of mashup candidate audio snippets, and generating a mashup audio snippet based on the audio snippet and the selected one of the subset of the plurality of mashup candidate audio snippets, the mashup audio snippet including at least one stem from the audio snippet and at least one stem from the selected one of the subset of the plurality of mashup candidate audio snippets.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a mashup system environment, in accordance with some embodiments.

FIG. 2 is a block diagram of a mashup platform of FIG. 1, in accordance with some embodiments.

FIG. 3 is an example of a waveform processed by a mashup platform to generate beat markings, in accordance with some embodiments.

FIG. 4 is an example of a waveform processed by a mashup platform to generate a chord string, in accordance with some embodiments.

FIG. 5 is a block diagram of a mashup search engine of a mashup platform of FIG. 2, in accordance with some embodiments.

FIG. 6 is an example of a waveform processed by a mashup platform to identify a metrical signature and a chord string based on a user's selection of an audio snippet for mashup search, in accordance with some embodiments.

FIGS. 7A-7B are example illustrations of a graphical user interface (GUI) provided by a mashup platform for user devices to preview candidate mashup matches and generate mashups with selective stem-level mixing, in accordance with some embodiments.

FIG. 8 is a flow chart illustrating a process for generating a mashup, in accordance with some embodiments.

FIG. 9 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

This disclosure pertains to an automated system for audio data extraction and mixing, designed to facilitate the creation of seamless song mashups. Techniques disclosed herein employ feature extraction, beat synchronization, and harmonic matching, enabling the creation of high-quality, cohesive song mashups with minimal manual intervention. The described process (operable on a system) may determine song structure using a metrical and harmonic information such as beat markings and chord strings to enable automatic mixing of songs with rhythmic interplay and harmonic cohesion.

In some embodiments, the system may employ advanced machine learning algorithms to extract raw musical features from audio files (e.g., songs) including stem, tempo, key, chord, beat/downbeat, and song structure. These features may then be used to generate beat markings and chord strings, which serve as the foundation for the mashup process. As used herein, an “audio file” may be any type of audio, audiovisual, or video file that includes an audio component that includes a plurality of stems or features that can be selectively mixed or mashed up with audio features or stems of another file. For example, the audio file may be a digital representation of a song or music stored in a predetermined file format (e.g., WAV, FLAC, MP3, CSV, JSON). The terms “audio file” and “song” may be used interchangeably in the present disclosure.

The extracted raw musical features of the audio files may be stored in association with the audio files as metadata including timestamped annotations of the features over time (e.g., for each beat of the song) or a plurality of stems (e.g., vocals, drums, bass, instruments, effects, and the like) that, when combined, form the music or song. The audio files and corresponding metadata may be stored in a mashup catalog.

In some embodiments, the system may create beat markings by combining the outputs of beat/downbeat detection and song structure analysis included in the timestamped metadata. The process may label each beat with three levels of metrical detail: beats, bars, and sections. This hierarchical representation ensures precise synchronization of rhythmic elements across different songs. The system may further generate chord strings by mapping chords detected for each beat based on the metadata to characters and concatenating these characters, providing a comprehensive harmonic profile of the song.

In some embodiments, the mashup platform may utilize the identified beat markings and harmonic profiles to identify, for an audio file snippet input by the user, potential matches within the mashup catalog. The search process may include a step of filtering songs based on tempo and key compatibility to identify mashup candidate snippets. The candidate snippets may then be evaluated for metrical and harmonic matches. In some embodiments, the system may perform pitch shifting to enhance compatibility between snippets, in case the initial search for harmonic matches fails to yield any results. Once suitable matches are identified, the system may time stretch and combine stems to generate candidate mashups for the user's consideration. The system may present, via a GUI, the candidate mashups for the user to audio preview and perform actions, e.g., save the mashup, share on social media, and the like. The GUI may also enable the user to provide a selection of which stems to use from which song to perform selective stem-level mixing (e.g., vocals from the input song and all other stems from the identified matching song, vocals and drums from the input song, and bass and instruments from the identified matching song, and the like).

### Example System Environment

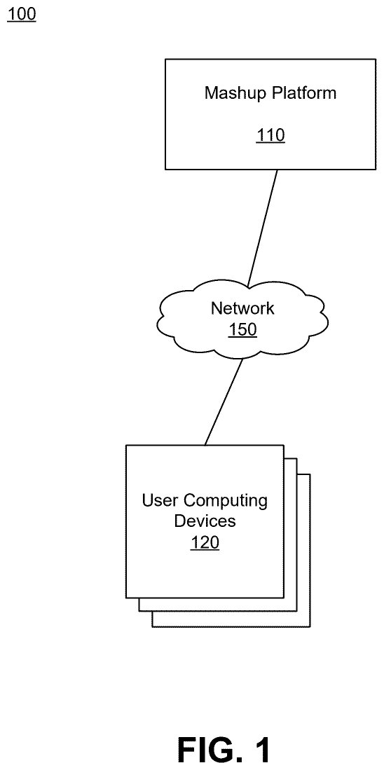

FIG. 1 illustrates a mashup system environment 100, according to some embodiments. The environment 100 of FIG. 1 includes a mashup platform 110 and user computing devices 120, communicatively coupled via a network 150. It should be noted that in other embodiments, the environment 100 may include different, fewer, or additional components than those illustrated in FIG. 1.

The mashup platform 110 may include one or more computing servers that provide functionality to users for creating mashups from a catalog of audio files (e.g., songs, instrumentals, narratives, and/or other audio). As used herein, a mashup may refer to an audio file that is generated by mixing two or more audio files. For example, songs may be separated into its constituent stems and the mashup may be created by selecting one or more stems from each song included in the mashup.

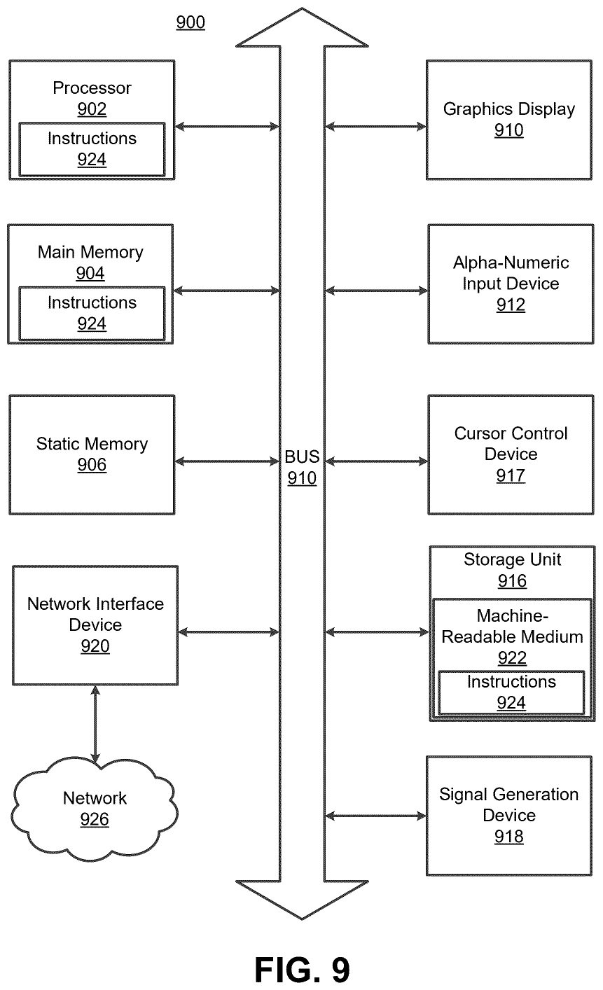

The mashup platform 110 operates as a system providing front-end and back-end functionality for automated music data extraction and mixing. The mashup platform 110 may be operated by an entity that uses a combination of hardware and software to build and operate the platform. A computing server used by the mashup platform 110 may include some or all example components of a computing machine described in FIG. 9. The computing server may be a computer system of one or more computing servers.

The mashup platform 110 may include a computing server that takes different forms. In some embodiments, the mashup platform 110 may be a server computer that executes code instructions to perform various processes described herein. In some embodiments, the mashup platform 110 may be a pool of computing devices that may be located at the same geographical location (e.g., a server room) or be distributed geographically (e.g., clouding computing, distributed computing, or in a virtual server network). In some embodiments, the mashup platform 110 may be a collection of servers that cooperatively provide music data extraction and mixing services to users as described. The mashup platform 110 may also include one or more virtualization instances such as a container, a virtual machine, a virtual private server, a virtual kernel, or another suitable virtualization instance.

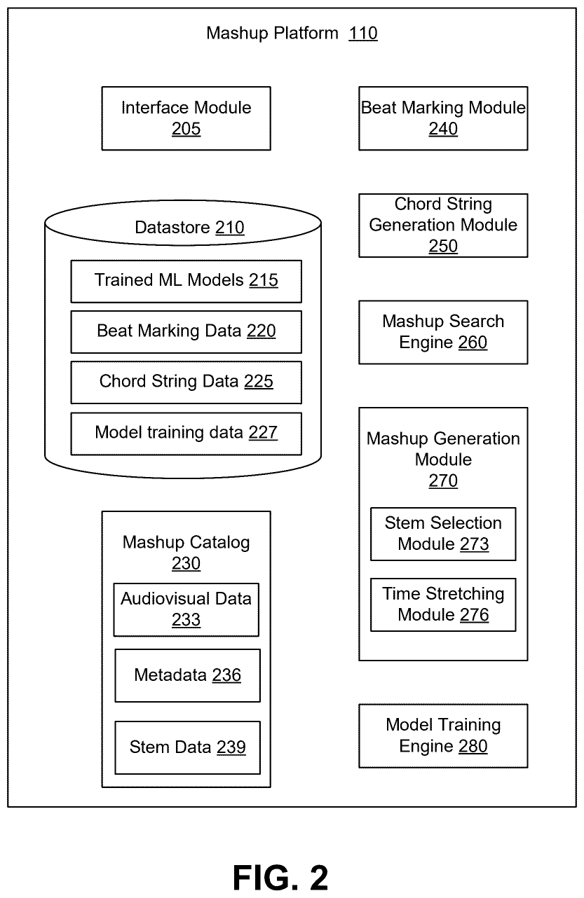

The mashup platform 110 may be an entity that controls software applications that are used by user computing devices 120. For example, the mashup platform 110 may be an application publisher that publishes mobile applications available through application stores (e.g., APPLE APP STORE, ANDROID STORE). In some cases, the application may take the form of a website and the mobile platform 110 is the website owner. The mashup platform 110 may provide users with various music extraction and mixing services as a form of cloud-based software, such as software as a service (SaaS), through the network 150. Examples of components and functionalities of the mashup platform 110 are discussed in detail below with reference to FIG. 2.

A user computing device 120 is a computing device that is possessed by an end user who may be a customer, a subscriber, or a user of the mashup platform 110. An end user may perform various actions in connection with the mashup platform 110 through an application (e.g., app of the mashup platform 110 downloaded and installed on the device 120 from an app store) that is operated by the mashup platform 110 with some features that may be provided or supported by sources external to the platform 110. For example, the actions may include the user interacting with a graphical user interface (GUI) of the application of the mashup platform 110 to select a song or upload a song to the platform 110 from an external source, browse mashup candidates for the song presented on the GUI of the application of the mashup platform 110, view song details of the mashup candidates, preview generated mashups for each candidate, selectively perform stem-level mixing of the search song with one or more of the mashup candidate songs to finetune the amount or type of audio content to retain from the original search song in the mashup and select the amount or type of audio content to include from the mashup candidate song(s) in the mashup. The actions may further include the user saving or downloading the mashup song, uploading the song to an external platform or service, sharing the mashup song on social media, and the like. Examples of user computing devices 120 include personal computers (PC), desktop computers, laptop computers, tablets (e.g., iPADs), smartphones, wearable electronic devices such as smartwatches and headsets, smart home appliances (e.g., smart TVs), vehicle entertainment systems, or any other suitable electronic devices.

The network 150 provides connections to the components of the mashup system environment 100 through one or more sub-networks, which may include any combination of the local area and/or wide area networks, using both wired and/or wireless communication systems. In some embodiments, the network 150 uses standard communications technologies and/or protocols. For example, network 150 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over network 150 may be represented using any suitable format, such as hypertext markup language (HTML), extensible markup language (XML), JavaScript object notation (JSON), structured query language (SQL). In some embodiments, all or some of the communication links of network 150 may be encrypted using any suitable technique or techniques such as secure sockets layer (SSL), transport layer security (TLS), virtual private networks (VPNs), Internet Protocol security (IPsec), etc. The network 150 may also include links and packet switching networks such as the Internet.

### Example Mashup Platform Components

FIG. 2 is a block diagram illustrating various components of an example mashup platform 110, in accordance with some embodiments. A mashup platform 110 may include an interface module 205, a datastore 210, a mashup catalog 230, a beat marking module 240, a chord string generation module 250, a mashup search engine 260, a mashup generation module 270, and a model training engine 280. The datastore 210 may store different types of data utilized, generated, or received by the mashup platform 110 for performing the different audio data extraction and mixing operations described herein. For example, the datastore 210 may store trained machine-learned models 215 for extracting features from songs, beat marking data 220, chord string data 225, and model training data 227. The mashup catalog 230 may include audiovisual data 233, metadata 236, and stem data 239. The mashup generation module 270 may include stem selection module 273, and time stretching module 276. In some embodiments, the mashup platform 110 may include fewer or additional components. The mashup platform 110 also may include different components. The functions of various components in the mashup platform 110 may be distributed in a different manner than described below. Moreover, while each of the components in FIG. 2 may be described in a singular form, the components may present in plurality.

The components of the mashup platform 110 may be embodied as software engines that include code (e.g., program code comprised of instructions, machine code, etc.) that is stored on an electronic medium (e.g., memory and/or disk) and executable by a processing system (e.g., one or more processors and/or controllers). The components also could be embodied in hardware, e.g., field-programmable gate arrays (FPGAs) and/or application-specific integrated circuits (ASICs), that may include circuits alone or circuits in combination with firmware and/or software. Each component in FIG. 2 may be a combination of software code instructions and hardware such as one or more processors that execute the code instructions to perform various processes. Each component in FIG. 2 may include all or part of the example structure and configuration of the computing machine described in FIG. 9.

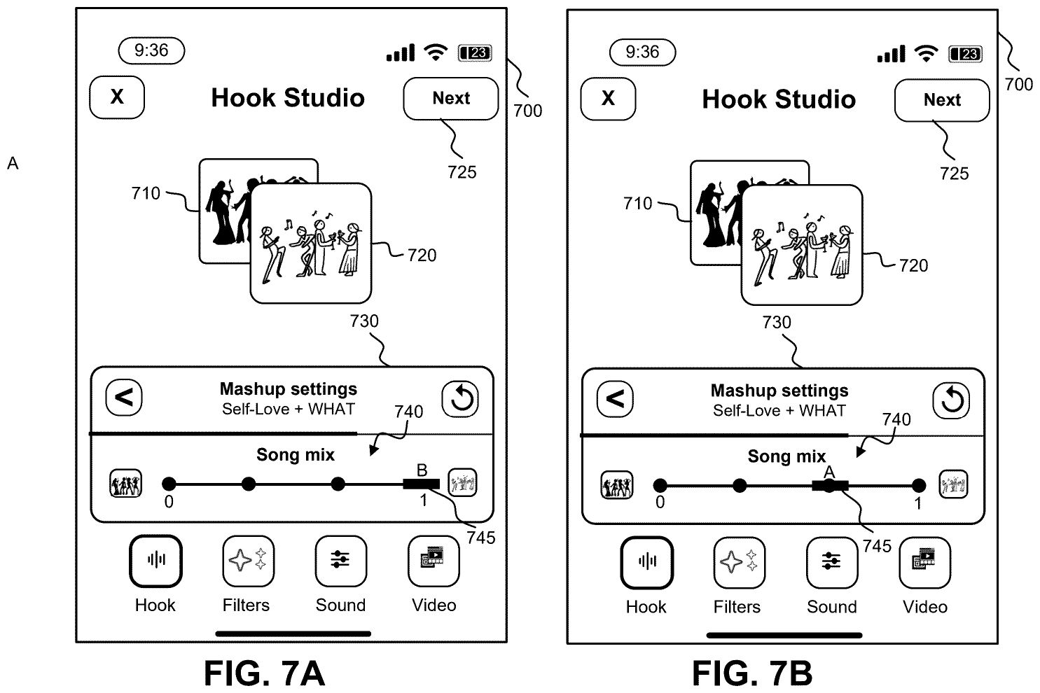

The interface module 205 may be an interface (e.g., GUI) for a user of a user computing device 120 to interact with the mashup platform 110. The interface module 205 may be a web application that is run by a web browser on a user device or a software as a service platform that is accessible by a user device through a network (e.g., network 150 of FIG. 1). In some embodiments, the interface module 205 may use application program interfaces (APIs) to communicate with user devices, which may include mechanisms such as webhooks. Example GUIs generated by the interface module 205 to enable user interaction with the mashup platform 110 are illustrated in FIGS. 7A-B described in detail below.

The mashup catalog 230 may be a database of audio files that can be utilized by the mashup platform 110 to generate mashups. In the embodiment shown in FIG. 2, the mashup catalog 230 is hosted by the mashup platform 110. In other embodiments, the mashup catalog 230 may be hosted by an external system such as a cloud-based hosting service or a third-party music service provider. For example, the mashup catalog 230 may be hosted as a subscription service and the mashup platform 110 may subscribe to the service to access content hosted on the mashup catalog 230.

The mashup platform 110 may procure applicable copyright licenses for the songs included in the catalog 230, ensuring that the rights of the original artists are protected. This may involve securing permissions for both the musical compositions and the audio recordings used in the mashups. Additionally, the platform 110 may include guardrails to ensure content in the mashup catalog 230 adheres to fair use guidelines and avoids unauthorized sampling of copyrighted material.

FIG. 2 shows the mashup catalog 230 may include audiovisual data 233, metadata 236, and stem data 239. The audiovisual data 233 may be a comprehensive catalog of licensed songs annotated by music professionals. For example, the audiovisual data 233 may include a plurality of audio files. For each of the plurality of audio files 233, the catalog 230 may include stem data 239 which may be data of one or more stems separated from the audio file, and metadata 236 which may indicate a tempo and a key of the audio file, and annotations for chord type, beat/downbeat, and song structure.

A “stem” refers to a group of related audio tracks mixed and rendered as a single file, allowing for more granular control and manipulation of specific musical elements during mixing, remixing, or mastering. That is, a song is made up of various elements (e.g., vocals, drums, bass, guitars), and the song is these elements or stems grouped together. For example, if a song has multiple guitar tracks, they might be grouped together into a guitar stem, which can be manipulated as a single unit. Common stems include vocals, drums, bass, guitars, synths/keys, instruments, and the like.

In some embodiments, the stem data 239 for each song or audio file (i.e., the different stems the song is separated or split into) in audiovisual data 233 may be generated using machine learning. For example, a trained machine-learned model 215 may extract stems from an input song or audio file and store as stem data 239 the separated stems as separate stem files associated with the input song. The stem separation model 215 may be trained by curating a dataset (e.g., model training data 227) of songs split into stems. For example, the model training data 227 for the stem separation model may be licensed an existing dataset of stems or may be a custom generated dataset obtained from composers and including original songs commissioned for the creation of the training data. Known deep neural network training procedures may then be performed using the licensed or commissioned dataset to train the machine-learned model for stem separation.

In some embodiments, the metadata 236 for each song or audio file may also be generated using machine learning. For example, one or more trained machine-learned models 215 may extract musical elements like tempo, key, chord, beat/downbeat, and song structure from an input song or audio file and store the extracted features as metadata 236. That is, a separate model 215 may be trained to extract each of the individual musical elements and implemented as a metadata generation pipeline, or a single model 215 may be trained to extract multiple musical elements from the input song. In some embodiments, the model 215 may be a foundation model trained to produce a rich, general representation of the musical characteristics of input audio. The foundation model 215 may be tuned to perform specific tasks to extract different types of metadata or perform stem separation. The metadata 236 may be timestamped with annotations for musical elements such as chord type, beat/downbeat, and song structure over a timeline for the audio file.

Each of the one or more models 215 for generating the metadata 236 may be trained by curating a licensed and/or custom dataset of songs (e.g., model training data 227) with the metadata labeled as the ground truth. Commercially available licensed datasets (e.g., GCX dataset) with this information annotated (e.g., songs annotated over time with tempo, key, chord, beat/downbeat) can be used to train the models 215 for metadata 236 extraction. Alternately, or in addition, custom datasets can be created with songs for which the necessary permissions have been obtained for use in model training. Music professionals can be employed to annotate/label over time songs in the custom database with the musical element information that the model is being trained to predict. Individual models can then be trained using a deep neural network architecture to predict each of the different types of metadata 236 (e.g., tempo, key, chord, beat/downbeat, song structure) separately, or some or all of these models may be combined to predict the information jointly. Information stored in the mashup catalog 230 can be used by the other components of the mashup platform 110 to perform mashup searches and create harmonically and rhythmically cohesive mashups.

In some embodiments, the timestamped metadata 236 and the stem data 239 may be extracted for each of the plurality of audio files in the audiovisual data 233 beforehand and stored as the mashup catalog 230. The user can then select, via a graphical user interface (GUI) presented on a user computing device 120, one of the audio files 233 for a mashup search, and the system will search for matching audio files 233 in the catalog 230 based on the input search song. In some embodiments, the user may provide their own search song that is not included in the catalog 230. In this case, the system may generate the metadata 236 and the stem data 239 for the input search song (after determining that the user and the system have applicable privileges (e.g., copyright license) to do so) using the trained ML models 215. The system may search for audio files 233 in the catalog 230 that match the input search song uploaded by the user from an external source.

The model training engine 280 trains machine-learned models (e.g., models 215) of the mashup platform 110. The model training engine 280 accesses data for training the models stored in datastore 210 as model training data 227. The model training data 227 can include empirical songs labeled to indicate: (i) stems (e.g., vocals, bass, drums, instruments) extracted from the empirical songs, (ii) tempo of the song, tempo of different sections of the song, (ii) key (e.g., major key, minor key) of the song, key of different sections of the song, (iii) tuples indicating time and beat/downbeat information at each time, (iv) tuples indicating other elements of the song such as bars, sections, and the like, (v) tuples indicating time and chord type.

The model training engine 280 may submit data for storage in datastore 210 as model training data 227. The model training engine 280 may receive labeled training data from a user or automatically label training data (e.g., using custom curated data labeled by music professionals). The model training engine 280 uses the labeled training data to train a plurality of machine-learned models 215. In some embodiments, the model training engine 280 uses user feedback to re-train the machine-learned models. The model training engine 280 may curate what training data to use to re-train a machine-learned model based on a measure of satisfaction provided in the user feedback. For example, the model training engine 280 receives user feedback indicating that a user is highly satisfied with the generated mashup. The model training engine 280 may then strengthen an association between features and a model output by creating training data using the features and machine-learned model outputs associated with the high satisfaction to re-train one or more of the machine-learned models. In some embodiments, the model training engine 280 attributes weights to training data sets or feature vectors. The model training engine 280 may modify the weights based on received user feedback and re-train the machine-learned models with the modified weights. By training a machine-learned model in a first stage using training data before receiving feedback and a second stage using training data as curated according to feedback, the model training engine 280 may train machine-learned models of the mashup platform 110 in multiple stages.

The beat marking module 240 is configured to generate beat markings for some or all of the audio files 233 in the mashup catalog 230 and store the generated beat markings as the beat marking data 220 in the datastore 210. The beat marking data 220 in the datastore 210 may be accessible by the mashup search engine 260 to search for mashup matches. The beat marking generated for each audio file 233 by the beat marking module 240 may indicate metrical information associated with the audio file. The metrical information may include for each of a plurality of beats of the audio file, a beat number, a bar number, and a section number.

Beat markings contain information generated based on song metadata 236 related to beat/downbeat detection and song structure analysis. For example, the beat/downbeat metadata 236 of the song may include is a list of tuples (e.g., beat time, beat number), each tuple describing a beat. Beat number describes the location of the current beat within a bar. If a beat number is 1, then the beat is a downbeat, if the beat number is 2, then the beat occurs 1 beat after a downbeat, and so on.

The song structure analysis metadata 236 of the song may include a hierarchical representation of song structure. For example, the song structure analysis metadata 236 may present a series of different snapshots of song structure with varying levels of granularity. The least granular snapshot may include only one or two sections for the whole song, while the most granular snapshot may split up the song into beats. Based on a knowledge of popular music, most songs have between 3 and 5 distinct sections (chosen from intro, pre chorus, chorus, verse, bridge, outro). Based on the song structure analysis metadata 236 of the song the beat marking module 240 may generate a granular snapshot that splits up the song into between 3 and 5 sections. A result may include a list of tuples (e.g., start time, section number), which specify the start time of each song section.

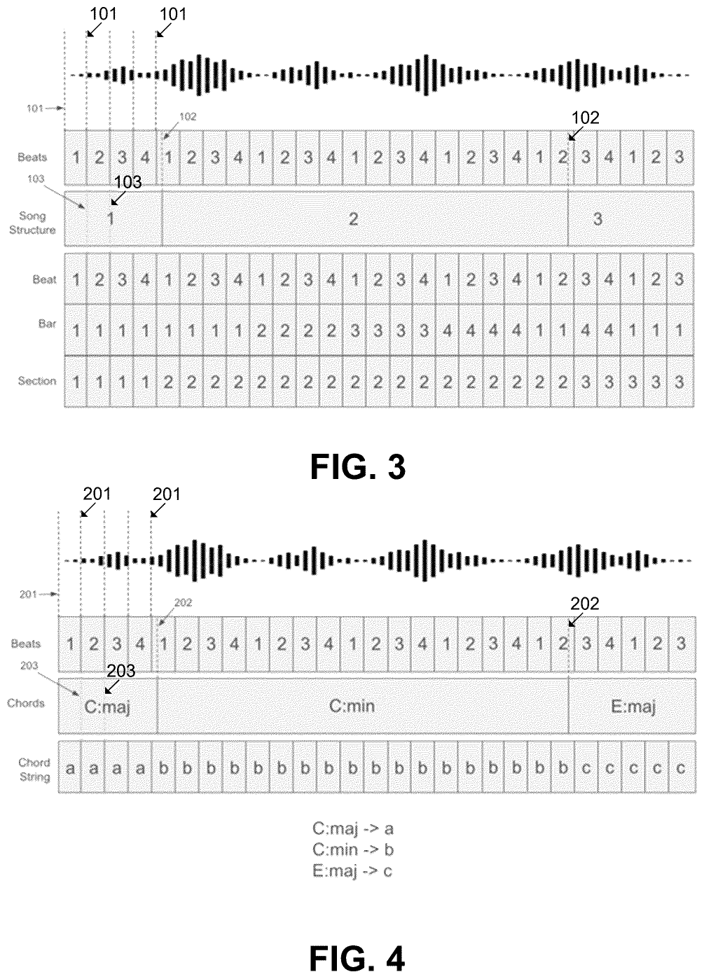

The process of generating the beat marking for a song by the beat marking module 240 based on the extracted metadata 236 is described in further detail below in connection with FIG. 3. In some embodiments, the beat marking module 240 may utilize the beat/downbeat detection metadata 236 and the song structure analysis metadata 236 to create a beat marking. In the example shown in FIG. 3, each beat (first row below the waveform) is labeled with 3 levels of metrical detail: beats, bars, and sections (last three rows). The most granular metrical information, beats, describes the location of the current beat within a bar. This is based on the output of the beat/downbeat detection by, e.g., the trained ML models 215 and stored as the beat/downbeat metadata 236. The least granular metrical information, section, is defined by the output of the song structure analysis described above. The beat marking module 240 assigns each beat inside a section to that section number. The final piece of metrical information, bars, refers to the location of a bar within a measure or musical phrase. The first downbeat of each section marks the beginning of a measure, and the bar number is set for each beat from there, based on the number of beats/bar and number of bars/measure for the given song. In the example shown in FIG. 3, both are 4.

FIG. 3 is an example beat marking indicating the metrical information associated with an audio file generated by the beat marking module 240 based on the metadata of the audio file. The beat marking module 240 may generate the beat marking in a similar manner for each of the files 233 in the catalog 230. The beat marking illustrated in FIG. 3 shows that the first row below the waveform refers to example beats output when there are four beats/bar. The dotted lines 101 show how beats divide up an original audio. The second row illustrates an example song structure metadata 236 output based on the song structure analysis. The bottom row, containing three sub-rows labeled with beats, bars, and sections, refers to an example beat marking generated by the beat marking module 240 based on the metadata 236 of features extracted from the song that indicate how to divide the song into beats and into sections based on song structure.

The dotted lines 103 show how the beat marking module 240 extends the metrical information each beat is labeled with. The dotted lines 102 show how the beat marking module 240 assigns a section to each beat. In some embodiments, the beat marking module 240 may determine, based on the annotations for the song structure in the metadata 236, for a given beat of a given audio file 233 in the mashup catalog 230 that is associated with a change in the song structure (e.g., beat corresponding to dotted line 102 in FIG. 3), a ratio between a portion of the given beat before the change to a portion of the given beat after the change. The beat marking module 240 may assign the section number (e.g., section number 2 assigned to the beat number 1 corresponding to the dotted line 102 in FIG. 3) to the given beat based on the determined ratio. For example, if a greater portion of the beat is under the new section number, then the new section number is assigned to the whole beat. This is illustrated in FIG. 3.

As shown in FIG. 3, scanning the diagram from left to right, the first dotted line 102 indicates that section two covers more of the beat containing the line 102 than section one. As a result, the beat marking module 240 assigns that beat to section two. The second dotted line 102 indicates that section two covers more of the beat containing the line than section three. As a result, the beat marking module 240 assigns that beat to section two. Finally, FIG. 3 illustrates a method of assigning a bar number when there are four beats/bar and four bars/measure, assigning the first downbeat of each section as a starting bar in a measure, and working from there.

More specifically, the beat marking module 240 restarts the bar numbering at the beginning of a new section per the following rule: the first downbeat (i.e., beat number 1) of each section marks the start of a new measure. In other words, the first downbeat of each section has a beat marking signature of (1,1,<section number>), and then the beat marking module 240 fills in the bar number for the rest of the section from there. For example, as shown in FIG. 3, in section 3, the bar number starts at 4. This is because the first downbeat in section 3 is the third beat in the section.

Returning to FIG. 2, the chord string generation module 250 is configured to generate chord strings associated with some or all of the audio files 233 in the mashup catalog 230 and store the generated chord strings as the chord string data 225 in the datastore 210. The chord string data 225 in the datastore 210 may be accessible by the mashup search engine 260 to search for mashup harmonic matches. The chord string generated for each audio file 233 by the chord string generation module 250 may indicate harmonic information associated with the audio file 233. The harmonic information may include a chord type for each of the plurality of beats of the audio file 233.

The chord strings contain information generated based on song metadata 236 related to chords or chord types. For example, the chord metadata 236 of the song may include a list of tuples (e.g., start time, chord type), each tuple specifying the location of each chord. The chord string generation module 250 may map each chord to a character. Further, the chord string generation module 250 may utilize the chord type metadata 236 to assign a character (representing a chord type) to each beat based on which chord most overlaps with that beat. Then, by concatenating the characters representing each chord over each beat, the chord string generation module 250 may obtain a chord string that represents the chords over the entire song. Operation of the chord string generation module 250 is further explained below in connection with FIG. 4.

FIG. 4 is an example chord string indicating the harmonic information associated with an audio file generated by the chord string generation module 250 based on the metadata 236 of the audio file. The chord string generation module 250 may generate the chord string in a similar manner for each of the files 233 in the catalog 230. The chord string illustrated in FIG. 4 shows that the first row below the waveform shows an example beats output, similar to that in FIG. 3. The second row below the waveform is the chord metadata 236 output, e.g., from a machine learning (ML) model 215 trained to predict tuples (e.g., start time, chord type) corresponding to the length of the song.

The dotted lines 201 show how beats split up an original audio. The third row in FIG. 4 and the dotted lines 203 show how the chord string generation module assigns a character corresponding to a chord to each beat. The chord characters concatenated together represent the chord string. The text at the bottom of FIG. 4 shows an example of how the chord string generation module 250 may map chords to characters.

Similar to FIG. 3, the dotted lines 202 show how the chord string generation module 250 may assign a chord to each beat. In some embodiments, the chord string generation module 250 may determine, based on the annotations for the chord type in the metadata 236, for a given beat of a given audio file 233 in the mashup catalog 230 that is associated with a change in the chord type (e.g., beat corresponding to dotted line 202 in FIG. 4), a ratio between a portion of the given beat before the change to a portion of the given beat after the change. The chord string generation module 250 may assign the chord type (e.g., character “b” assigned to the beat number 1 corresponding to the dotted line 202 in FIG. 4) to the given beat in the chord string based on the determined ratio. For example, if a greater portion of the beat is under the new chord type, then the new chord type and corresponding character is assigned to the whole beat. This is illustrated in FIG. 4.

As shown in FIG. 4, scanning the figure from left to right, the first dotted line 202 indicates that the chord C:min covers more of the beat with the dotted line within it than C:major does. Thus, the chord string generation module 250 may assign that beat to “b”, the character corresponding to C:min, rather than “a”, the character corresponding to C:maj.

Returning to FIG. 2, the mashup search engine 260 may perform a mashup search for matching songs in the mashup catalog 230 based on a selection by a user of a particular song, the selection received via a GUI presented on a user computing device of the user.

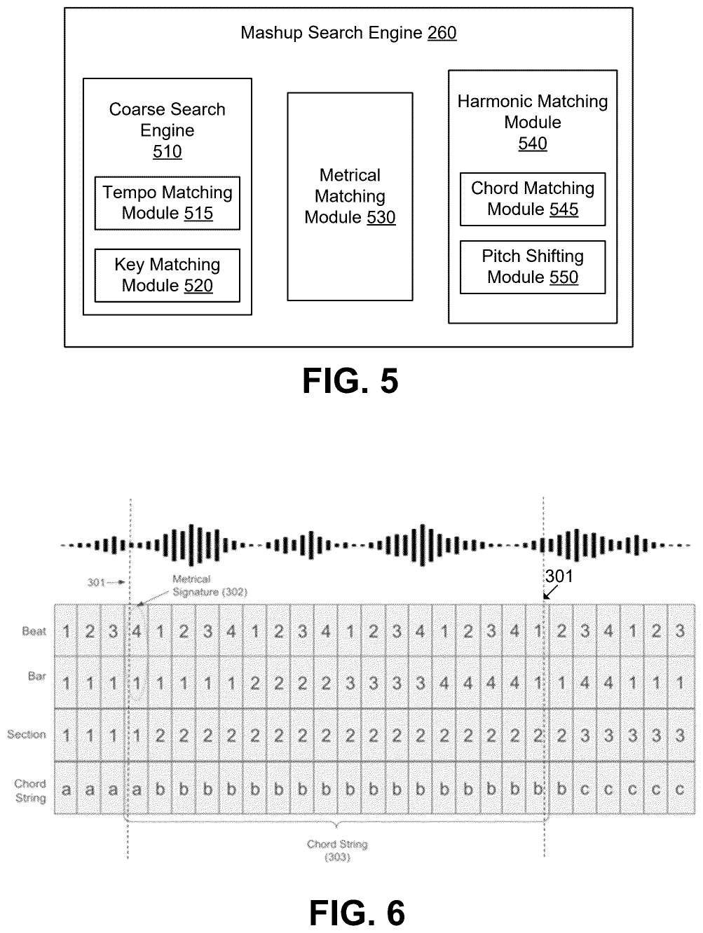

In some embodiments, the mashup search engine 260 may receive a selection of an audio snippet of a particular song 233 via the GUI presented on the user computing device of the user. For example, the user's selection on the GUI may indicate a particular song indicated, e.g., by an identifier of an audio file 233. Further, the user's selection on the GUI may indicate a start time and an end time associated with the selected audio file, the start time and the end time defining the audio snippet with respect to which the user wishes to generate a mashup or mix based on mashup candidate snippets identified by the mashup search engine 260. In some embodiments, the audio file associated with the user provided identifier may be from among a plurality of audio files 233 in the mashup catalog 230. In other embodiments, the audio file may be a new file uploaded by the user into the platform 110 for performing the mashup search and mixing. Details of the process performed by the mashup search engine 260 are described below in connection with FIGS. 5-6.

### Example Mashup Search Engine Components

FIG. 5 is a block diagram illustrating various components of an example mashup search engine 260, in accordance with some embodiments. A mashup search engine 260 may include a coarse search engine 510, a metrical matching module 530, and a harmonic matching module 540. The coarse search engine 510 may include a tempo matching module 515 and a key matching module 520. The harmonic matching module 540 may include a chord matching module 545 and a pitch shifting module 550. The mashup search engine 260 also may include different components. The functions of various components in the mashup search engine 260 may be distributed in a different manner than described below.

The coarse search engine 510 may perform, based on the audio file corresponding to the audio snippet selected by the user, a coarse search to identify from among the audio files 233 in the mashup catalog 230, a subset of audio files that are to be processed further in the search pipeline to identify mashup candidate snippets. This coarse search step makes the overall search process less computationally intensive than conventional systems, resulting in a search and mashup generation engine that reduces the amount of data and processing power required to identify mashup matches that are compatible, harmonically cohesive, and that sound on-beat.

To perform the coarse search, the tempo matching module 515 may identify, from among the plurality of audio files 233 in the mashup catalog 230, a subset of audio files that are within a threshold tempo distance from a tempo of the audio file 233 corresponding to the input search snippet. For example, the tempo matching module 515 may identify a tempo of the input audio snippet (or the associated audio file 233) based on the corresponding metadata 236. The tempo matching module 515 may then iterate through all other songs 233 within the mashup catalog 230 (e.g., a database of songs), and ignore (e.g., not process further) songs that are more than 10% of the tempo distance away from the search snippet in tempo (i.e., for a song with tempo 100 beats per minute (BPM), the tempo matching module 515 may identify songs within a tempo range 90-110 as containing potential matches). Tempo is an indication of how long each beat is. For example, if tempo of the input audio snippet is 100 BPM, that indicates that each beat is 0.6 seconds. To ensure that each beat of the two or more sections/snippets/songs mashed up are lined up to be the same length, where this can be achieved with not more than a threshold amount of time stretching, the tempo matching module 515 only consider songs as containing potential matches if they are close enough in tempo, i.e., within a predetermined tempo distance.

Further, as part of the coarse search, the key matching module 520 may identify, from among the plurality of audio files 233 in the mashup catalog 230, a subset of audio files that satisfy a predetermined key relationship with a major key or a minor key of the audio file 233 corresponding to the input search snippet. The coarse search engine 510 may identify a subset of audio files that satisfy both the tempo condition of the tempo matching module 515 and the key condition of the key matching module 520 as the subset of audio files that are to be processed further in the search pipeline to identify mashup candidate snippets.

Key is an indication of what kinds of chords are within a song. In some embodiments, to identify the subset of audio files that satisfy the predetermined key relationship, the key matching module 520 may determine, based on the metadata 236 indicating the key of the audio file (or of the search snippet of the audio file), whether the audio file is in the major key or in the minor key. In response to determining that the audio file 233 is in the major key, the key matching module 520 may ignore audio files 233 in the mashup catalog 230 that are in the minor key except for audio files that are in a relative minor key to the key of the audio file 233 (e.g., A:min is the relative minor to C:maj). Similarly, in response to determining that the audio file 233 corresponding to the search snippet is in the minor key, the key matching module 520 may ignore audio files 233 in the mashup catalog 230 that are in the major key except for audio files 233 that are in a relative major key to the key of the audio file associated with the search snippet. Since the goal of the mashup search is to find a chord match between two sections/songs/snippets that are mashed up, and since it is unlikely that there will be a chord match between songs where one is in a major key and the other is in a minor key, unless those major and minor keys share a relative major/minor relationship, the key matching module 520 ignores the audio files 233 as explained in the this paragraph. Since a check for beat/chord matches (performed by the modules 530 and 540) is more computationally intensive than the check for a tempo/key match (performed by engine 510), the search pipeline implemented by the search engine 260 may perform the coarse filtering with the coarse search module 510 first, and remove songs 233 that fail on this step from the subsequent step of identifying beat/chord matches. This results in faster processing time and improved user experience.

Using the metadata 236 of the search audio snippet (or audio file 233) which indicates the tempo and the key of the audio snippet, and using the beat marking data 220 and the chord string data 225 of the search audio snippet, the mashup search engine 260 may perform a mashup (or mixing) search. The metrical matching module 530 may accept as input, the song ID, start time, and end time for a given song and snippet received from the user, and identify a metrical signature of the audio snippet. The metrical signature may include a beat number and a bar number associated with a beat of the audio file corresponding to the start time. Similarly, the harmonic matching module 540 may accept as input, the song identifier (ID), start time, and end time for the given song and snippet received from the user, and identify a chord string of the audio snippet. The chord string may indicate a chord type for each beat of the audio snippet. Next, the mashup search engine 260 performs an analysis of the beat marking metrical signature of the first beat in the snippet, as well as the chord string of the beats contained within the snippet. This is explained in further detail in connection with FIG. 6 below.

In FIG. 6, the waveform represents the audio of an example input song selected by the user for mashup search. The dotted lines 301 that intersect with the waveform represent the start time and end time of a snippet of the input song for which the user would like to find a suitable mashup. The first three rows below the waveform display the metrical information assigned to each beat in the beat marking data 220 of the input song. The bottom row displays the harmonic information assigned to each beat in the chord string data 225 for the input song. The bracket 303 and the dotted lines 301 indicate how the mashup search engine 260 selects the start beat and the end beat used to identify information needed to conduct the mashup search. Scanning the figure from left to right, the first dotted line 301 indicates that the start time (provided by the user and corresponding to the start of the snippet) is between the fourth and fifth beat, but that it is closer to the fourth beat. Thus, the search engine 260 treats the fourth beat as the start beat for the snippet. The search engine 260 thus uses the metrical information of the fourth beat in this instance as a basis for the mashup search. The oval 302 indicates that the beat and bar information from the start beat is identified and used by the search engine 260 as the metrical signature of the search snippet. Like with the start beat, the end beat is determined by the search engine 260 based on the closest beat to the end time of the snippet. This is indicated by the dotted line 301 and the bracket 303. The chord string 303 corresponding to the search snippet consists of the characters representing chords assigned to each of the beats between the start and end beat: in this instance an 18-character string corresponding to a snippet that has length 18 beats. In some embodiments, spectrogram information may be used to perform the mashup search. For example, the string 303 in FIG. 6 may include spectrogram information for each of the 18 beats. This information may be used, instead of, or in addition to, the harmonic information to identify matching snippet candidates.

Based on the identified metrical signature 302, the metrical matching module 530 may identify, from among the subset of audio files identified by the coarse search engine 510, a plurality of mashup candidate audio snippets that match the metrical signature (e.g., 302 in FIG. 6) of the search audio snippet input by the user and that have a beat length that matches a beat length (e.g., 18 beats in FIG. 6) of the audio snippet.

That is, for each remaining song (remaining after the filtering by the coarse search engine 510), the metrical matching module 530 may identify all beats of the song that have the same beat marking metrical signature as the search snippet and have at least the number of beats in the snippet left in the song following the matching beat (e.g., if search snippet is 10 beats long, match beat is at beat 100 in the match song, and there are only 105 beats, then the metrical matching module 530 will not identify this as a match). In the example of FIG. 6, the metrical matching module 530 would find all instances in the song catalog where beats are labeled in its beat marking data 220 with beat 4, bar 1, and select snippets starting from those beats with length 18 beats (i.e., the length of the search snippet in the example of FIG. 6) as candidate snippet matches. In some embodiments, the search process may end here, if the metadata associated with the search input snippet meets predetermined conditions. For example, if the metadata 236 of the audio file 233 corresponding to the search snippet indicates that it is a rap song, the process may stop and the search engine 260 may recommend all 18-beat snippets identified by the metrical matching module 530 as potential matches, since vocals from the search snippet will fit on a metrically matching instrumental regardless of its harmonics.

If the predetermined condition described above is not met, the pipeline outputs the metrical matches from the metrical matching module 530 to the chord matching module 545 to analyze the chords over candidate matches with matching metrical signatures to identify harmonic matches. Continuing with the example of FIG. 6 above, for each of the 18-beat snippets identified by the metrical matching module 530, the chord matching module 545 of the harmonic matching module 540 may obtain a chord string for the 18 beats of the snippet based on the chord string data 225 corresponding to the songs 233 of the mashup catalog 230. The chord matching module 545 may the compare the chord string of the input search audio snippet with respective chord strings of each of the plurality of mashup candidate audio snippets to identify a subset of the plurality of mashup candidate audio snippets that harmonically match the audio snippet. That is, the chord matching module 545 may, for each candidate audio snippet that matches a beat length of the input search audio snippet and that is identified by the metrical matching module 530, compare the chords of the candidate snippet with the respective chords at the same position per the chord string (e.g., 303) of the input search snippet. In some embodiments, the chord matching module 545 may confirm a match between two chord strings if at least half of the chords in the same position in both strings are the same or are related to each other. In other words, to identify the subset of the plurality of mashup candidate audio snippets, the chord matching module 545 may determining for each of the plurality of mashup candidate audio snippets, whether chord types of at least half of the beats in the chord string of the mashup candidate audio snippet match or are related to chord types of respective beats at same positions in the chord string of the audio snippet.

For example, the chord matching module 545 determines two chords (chord string of the search snippet and chord string of the metrically matching candidate snippet with same beat length) that are both major chords or both minor chords to be related to each other if they have a perfect fifth relationship, or in other words when they are seven semitones apart (i.e., G:maj is a perfect fifth up from C:maj, G:min is a perfect fifth up from C:min, F:maj is a perfect fifth down from C:maj, F:min is a perfect fifth down from C:min). An octave contains 12 notes, C, C #, D, D #, E, F, F #, G, G #, A, A #, B. A single step between each of these notes, as well as from B to C, is called a semitone step. For example, one semitone up from C is C #, one semitone down from C is B, two semitones up from E is F #, two semitones down from E is D, and so on. Chords are said to a perfect fifth relationship if their root notes are seven semitones apart.

Further, the chord matching module 545 may determine two chords (chord string of the search snippet and chord string of the metrically matching candidate snippet with same beat length) where one chord is a major chord and one chord is a minor chord to be related to each other if the minor chord is the relative minor of the major chord, or in other words, if the minor chord corresponds to the sixth note in the scale of the major chord (e.g., A:min is the relative minor to C:maj). Minor chords and major chords differ because they are derived from different kinds of scales, a major chord is taken from a major scale, and a minor chord is taken from a minor scale. The closest minor scale to any major scale is called the “relative minor”, and it can be obtained by looking at the sixth note in the major scale. The notes of a major scale are defined by semitone steps from the root note, in the following pattern (2-2-1-2-2-2-1). So following this pattern, the C major scale can be obtained as C, D, E, F, G, A, B. As explained above, D is 2 semitones up from C, E is 2 semitones up from D, F is one semitone up from E, and so on. Thus, the sixth note in the scale is A, which would make A the relative minor to C major.

The chord matching module 545 may thus identify the subset of the candidate snippets that both metrically and harmonically match the search input snippet. Returning to FIG. 2, the output of the chord matching module 545 may be used by the mashup generation module 270 to provide a preview to the user of the matches identified by the chord matching module 545. In some embodiments, the mashup generation module 270 may further filter the subset of snippets identified by the chord matching module 545 and suggest the filtered list of snippets as matches to the user. For example, the mashup generation module 270 may limit the number of matches to be presented from any given song. In some embodiments, the mashup generation module 270 may recommend to the user via the interface module 205, up to three candidate snippets (each having the same beat length as the search snippet and each identified as a match by the chord matching module 545) from any given song 233. To narrow down the recommended matches for any given song, the mashup generation module 270 may include predetermined criteria. As one example, if the chord matching module 545 has identified more than three matches for a given song 233, the mashup generation module 270 may suggest matches that are in distinct sections of that song. As another example, if the chord matching module 545 has identified more than one match within a given section of a given song, the mashup generation module 270 may suggest the snippet with the highest overlap of exact or related chords in that section as a match (e.g., aaaa->aaaa is a stronger match than aaab->aaaa).

The interface module may present to the user, via the GUI presented on the user computing device, the filtered list of candidate snippets. The user may interact with the GUI to input a selection of one or more of the filtered subset of the plurality of mashup candidate audio snippets. The mashup generation module 270 may generate a mashup based on the input selection from the user.

In some embodiments, the chord matching module 545 may determine, based on the comparing of the chord string of the audio snippet with the respective chord strings of each of the plurality of mashup candidate audio snippets, that none of the plurality of mashup candidate audio snippets harmonically match the audio snippet. That is, the chord matching module 545 may fail to identify any snippets output from the metrical matching module 530 as harmonically matching the search input snippet (e.g., at least half of the beats in the two chord strings do not match and are not related to each other).

For such cases, the pitch shifting module 550 may process the results output of the metrical matching module 530 to determine if pitch shifting the candidate song snippet will yield matches. In some embodiments, the pitch shifting module may perform a first pitch shift for each of the plurality of mashup candidate audio snippets to identify a subset of the plurality of mashup candidate audio snippets after the first pitch shift that harmonically match the audio snippet. Further, based on a comparison of the chord string of the audio snippet with respective chord strings of each of the plurality of mashup candidate audio snippets after the first pitch shift, the pitch shifting module 550 may determine that none of the plurality of mashup candidate audio snippets after the first pitch shift harmonically match the audio snippet. In this case, the pitch shifting module 550 may perform a second pitch shift for each of the plurality of mashup candidate audio snippets to identify a subset of the plurality of mashup candidate audio snippets after the second pitch shift that harmonically match the audio snippet, wherein the second pitch shift is by a greater number of semitones than the first pitch shift. Thus, in some embodiments, the pitch shifting module 550 iteratively shifts the pitch of the candidate snippets until a match is identified, and then stops the process. The pitch shifting module 550 may iteratively perform the pitch shift process for up to six semitones before stopping the process. In some embodiments, the pitch shifting module 550 may first determine if pitch shifting the metrically matching candidate audio snippets would make the keys of the two songs the same, e.g., if a search song has key “A:maj” and the candidate song has key “C:maj”, then the pitch shifting module 550 may first pitch shift the candidate song down three semitones so that the candidate song is now in key “A:maj” and determine if the candidate song in key “A:maj” will now yield matches. If the pitch shifting module 550 is unable to find matches with this key matching method, then the pitch shifting module 550 may perform the iterative process described above where it performs the pitch shift by upto 6 semitones, in incremental order of, e.g., pitch shifting the candidate songs+1 semitone, then −1 semitone, then +2 semitones, then −2 semitones, and so on, until a match is found.

For example, if the chord matching module 545 determines that no matches are identified for a given song 233 associated with the input search snippet where the metrical matching module 530 has identified metrical matches, the pitch shifting module 550 determines if pitch shifting the metrically matching candidate audio snippets will yield matches. The pitch shifting module 550 may attempt to pitch shift the metrically matching candidate song snippet by up to 6 semitones and return matches the moment it identifies them. For example, if the pitch shifting module 550 identifies one or more matches after shifting each of the metrically matching candidate song snippets by 1 semitone, the pitch shifting module 550 may stop the pitch shifting process there and return the identified matches, without further performing the pitch shifting process for the metrically matching candidate song snippets by 2, 3, 4, 5, or 6 semitones. In some embodiments, the pitch shifting module 550 can determine if pitch shifting a candidate snippet would yield a match by shifting all the chords in the chord string for the snippet. For example, if b=D:maj, a=C:maj, the chord string for the input audio search snippet is bbbb, and the chord string for a potential metrically matching candidate is aaaa, the two snippets are initially not detected as harmonic matches. However, if there is a pitch shift of the potential candidate up by 1 semitone (C:maj up one semitone is D:maj), then the chord string for the potential candidate becomes bbbb, which is now a match.

### Example Mashup Composition Module

Returning to FIG. 2, the mashup generation module 270 may receive the mashup candidates identified as metrical and harmonic matches output by the mashup search engine 260. In some embodiments, the mashup generation module 270 may receive, via the GUI presented on the user computing device, a selection of one of the subset of the plurality of mashup candidate audio snippets (i.e., the mashup candidates identified as metrical and harmonic matches by the mashup search engine 260), and the mashup generation module 270 may generate a mashup audio snippet based on the audio snippet and the selected one of the subset of the plurality of mashup candidate audio snippets, the mashup audio snippet including at least one stem from the audio snippet and at least one stem from the selected one of the subset of the plurality of mashup candidate audio snippets.

In some embodiments, the mashup generation module 270 may receive, via the GUI presented on the user computing device, a selection representing a number of stems of the selected one of the subset of the plurality of mashup candidate audio snippets to be included in the generated mashup audio snippet. The mashup generation module 270 may generate the mashup audio snippet based on the received selection.

That is, in some embodiments, once snippets from songs are identified based on the operation of the search engine 260 (each identified snippet having the same number of beats as the input search snippet and satisfying the conditions (e.g., harmonic match, metrical match) for a mash up), the mashup generation module 270 may generate a mashup as explained below. First, the stem selection module 273 may access the stem data 239 of the song 233 associated with the input search snippet and the stem data 239 of each candidate matching snippet, where the stems may be separated or split from the associated song by a trained stem separation model 215. For example, the different stems for each of the input search song and the candidate matching song may include vocals, drums, bass, instruments, and the like. In some embodiments, the stem selection module 273 may, based on predetermined rules, automatically configure which stems to take from the input search song and which stems to take from the matching candidate song to generate the mashup. For example, the stem selection module 273 may take vocals from the search song, and mash that up with the remaining stems from the match song.

The time stretching module 276 may employ known time stretching algorithms to time stretch all the stems selected by the stem selection module 273 so that they are the same length. Since the time stretching module 276 configures all the stems selected by the stem selection module 273 to be the same length, they will sound on beat when playing together. While the two snippets (i.e., the input search snippet and the candidate matching snippet) at this point are the same length in beats, that does not mean they are the same length in time, because different songs have different beat lengths, as determined by their tempo. To account for this difference, the time stretching module 276 time stretches the stems so that the two snippets that are to be mashed up together are the exact same length in time. For example, if the search snippet is a 10-beat snippet that is 10 seconds long, and the candidate match snippet is a 10-beat snippet that is 12 seconds long, then the time stretching module 276 would time stretch the match snippet by a ratio of 10/12=0.8333, such that these two snippets would now be the same length in terms of time. In some embodiments, the time stretching module 276 may time stretch both the match snippet and the input search snippet to somewhere in the middle to make the two song snippets of equal length while reducing the amount of time stretching applied to each snippet.

In some embodiments, the stem selection module 273 may determine which stems to take from which song based on user input. This is illustrated further in detail below in connection with FIGS. 7A-7B. FIGS. 7A-7B are example illustrations of a graphical user interface (GUI) 700 provided by a mashup platform for user devices to preview candidate mashup matches and generate mashups with selective stem-level mixing, in accordance with some embodiments. FIGS. 7A-7B show that a state where the mashup search engine 260 has identified a plurality of metrical and harmonic matches for the user identified snippet of the selected search song 710 (“self-Love”). The user can interact with the interface element 725 to switch through the candidate matches and preview what the mashup for each candidate match may sound like, as well as perform additional actions.

FIGS. 7A-7B show a state where the current selected candidate audio snippet is a snippet associated with the candidate song 720 (“WHAT”). The mashup generation module 270 may enable the user to perform selective stem-level mixing between the search song 710 and the candidate song 720 by interacting with the interface element 730. FIGS. 7A-7B show that the interface element 730 includes a song mix slider 740 that the user can interact with to set the extent of the mixing of the candidate song 720 with the search song 710 in the generated mashup. That is, for example, the user may incrementally slide switch 745 between positions 0 and 1 to increase the number of stems from the candidate matching song 720 that are to be included in the mashup. For example, each of the songs 710 and 720 may include in the stem data 239 stems for vocals, bass, drums, and instruments. In the state shown in FIG. 7B where the switch 745 is at position A along the slider 740, the stem selection module 273 may select two stems (e.g., vocals, bass) from the input search song 710, and select the remaining stems (e.g., drums, instruments) from the candidate song 720. And in the state shown in FIG. 7A where the switch 745 is at position B along the slider 740, the stem selection module 273 may select one stem (e.g., vocals) from the input search song 710, and select the remaining stems (e.g., bass, drums, instruments) from the candidate song 720.

The user may thus interact with the GUI 700 to preview and generate one or more desired mashups and perform predetermined actions. For example, the user may confirm the mashup preview and click on the “Hook” interaction element on the GUI 700 to confirm their candidate song and stem-level mixing selections and cause the mashup generation module 270 to generate and save a mashup. Other actions supported by the system may include the ability to download the mashup; share the mashup using social media, messaging apps, and the like; upload the mashup to an external music service or platform; and the like.

The mashup generation module 270 may also provide additional functionality to the user to generate mashups. For example, the mashup generation module 270 may allow the user to mash up more than two songs, taking at least one stem from each song (e.g., mashup the input search song with at least two of the candidate matching songs identified by the mashup search engine 260). As another example, the mashup generation module 270 may allow the user to use multiple songs for the same stem, switching from one song to another at some point or mixing the stems from the two songs together.

### Example Process for Generating a Mashup

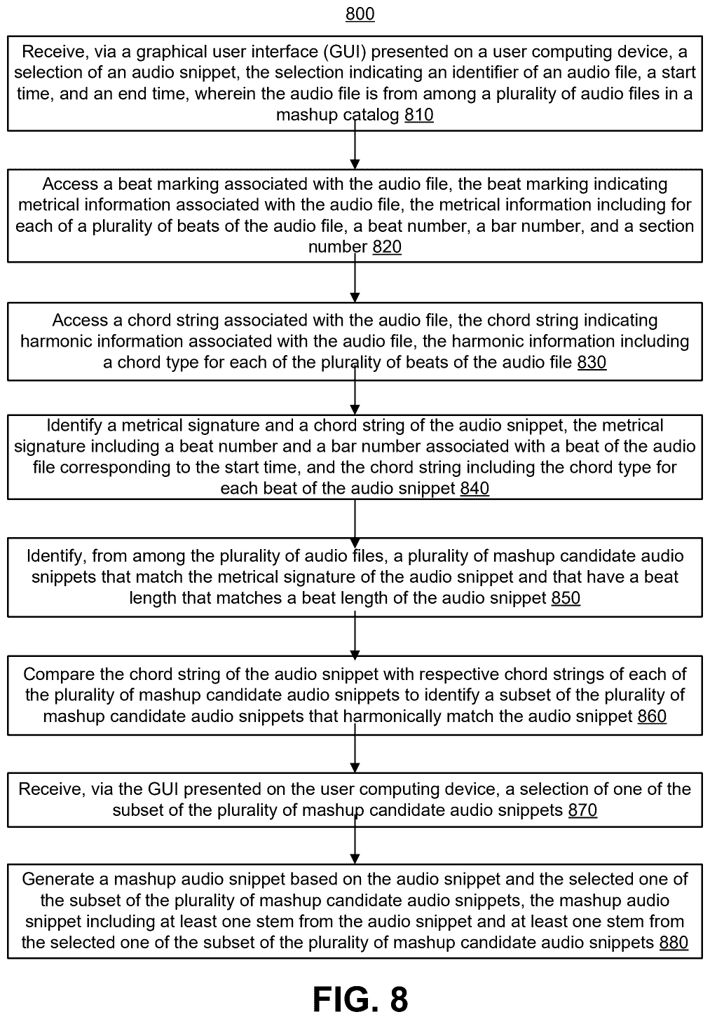

FIG. 8 is a flow chart illustrating a process 800 for generating a mashup, in accordance with some embodiments. It should be noted that the process illustrated herein can include fewer, different, or additional steps in other embodiments. Process 800 may be performed by components of the mashup platform 110. The interface module 205 may receive 810, via a graphical user interface (GUI; e.g., GUIs 700 in FIGS. 7A-7B) presented on a user computing device (e.g., 120 in FIG. 1), a selection of an audio snippet, the selection indicating an identifier of an audio file (e.g., 233 in FIG. 2), a start time, and an end time (e.g., snippet corresponding to 303 in FIG. 6), wherein the audio file 233 is from among a plurality of audio files 233 in a mashup catalog 230.

The beat marking module 240 may access 820 (or generate) a beat marking (e.g., stored as beat marking data 220) associated with the audio file, the beat marking indicating metrical information associated with the audio file (FIG. 3), the metrical information including for each of a plurality of beats of the audio file, a beat number, a bar number, and a section number (FIG. 3). The chord string generation module 250 may access 830 (or generate) a chord string (e.g., stored as chord string data 225) associated with the audio file, the chord string indicating harmonic information associated with the audio file (FIG. 4), the harmonic information including a chord type for each of the plurality of beats of the audio file (FIG. 4).

The mashup search engine 260 may identify 840 a metrical signature (e.g., 302 in FIG. 6) and a chord string (e.g., 303 in FIG. 6) of the audio snippet, the metrical signature including a beat number and a bar number associated with a beat of the audio file corresponding to the start time (FIG. 6), and the chord string including the chord type for each beat of the audio snippet (FIG. 6). The metrical matching module 530 may identify 850, from among the plurality of audio files 233 in the mashup catalog 230, a plurality of mashup candidate audio snippets that match the metrical signature of the audio snippet and that have a beat length that matches a beat length of the audio snippet.

The harmonic matching module 540 may compare 860 the chord string of the audio snippet (e.g., 303 in FIG. 6) with respective chord strings of each of the plurality of mashup candidate audio snippets to identify a subset of the plurality of mashup candidate audio snippets that harmonically match the audio snippet. The interface module 205 may receive 870, via the GUI presented on the user computing device (e.g., GUI 700 in FIGS. 7A-7B), a selection of one of the subset of the plurality of mashup candidate audio snippets (e.g., 720 in FIGS. 7A-7B).

The mashup generation module 270 may generate 880 a mashup audio snippet based on the audio snippet (e.g., 710 in FIGS. 7A-7B) and the selected one of the subset of the plurality of mashup candidate audio snippets (e.g., 720 in FIGS. 7A-7B), the mashup audio snippet including at least one stem from the audio snippet and at least one stem from the selected one of the subset of the plurality of mashup candidate audio snippets.

### Example Computer System

FIG. 9 is a block diagram illustrating components of an example machine for reading and executing instructions from a non-transitory machine-readable medium, in accordance with one or more example embodiments. Specifically, FIG. 9 shows a diagrammatic representation of one or more of the mashup platform 110, the user computing devices 120, and the machine for performing the process 800 of FIG. 8 in the example form of a computer system 900.

The computer system 900 can be used to execute instructions 924 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes one or more processing units (generally processor 902). The processor 902 is, for example, a central processing unit (CPU), a graphics processing unit (GPU), a digital signal processor (DSP), a control system, a state machine, one or more application specific integrated circuits (ASICs), one or more radio-frequency integrated circuits (RFICs), or any combination of these. The computer system 900 also includes a main memory 904. The computer system may include a storage unit 916. The processor 902, memory 904, and the storage unit 916 communicate via a bus 908.

In addition, the computer system 900 can include a static memory 906, a graphics display 910 (e.g., to drive a plasma display panel (PDP), a liquid crystal display (LCD), or a projector). The computer system 900 may also include an alphanumeric input device 912 (e.g., a keyboard), a cursor control device 917 (e.g., a mouse, a trackball, a joystick, a motion sensor, or other pointing instrument), a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. For example, the instructions 924 may include the functionalities of modules of one or more of the mashup platform 110, or user computing devices 120 of FIG. 1, and the machine for performing the process 800 of FIG. 8. The instructions 924 may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 may be transmitted or received over a network 926 via the network interface device 920.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method, comprising:
receiving, via a graphical user interface (GUI) presented on a user computing device, a selection of an audio snippet, the selection indicating an identifier of an audio file, a start time, and an end time, wherein the audio file is from among a plurality of audio files in a mashup catalog;
accessing a beat marking associated with the audio file, the beat marking indicating metrical information associated with the audio file, the metrical information including for each of a plurality of beats of the audio file, a beat number, a bar number, and a section number;
accessing a chord string associated with the audio file, the chord string indicating harmonic information associated with the audio file, the harmonic information including a chord type for each of the plurality of beats of the audio file;
identifying a metrical signature and a chord string of the audio snippet, the metrical signature including a beat number and a bar number associated with a beat of the audio file corresponding to the start time, and the chord string including the chord type for each beat of the audio snippet;
identifying, from among the plurality of audio files, a plurality of mashup candidate audio snippets that match the metrical signature of the audio snippet and that have a beat length that matches a beat length of the audio snippet;
comparing the chord string of the audio snippet with respective chord strings of each of the plurality of mashup candidate audio snippets to identify a subset of the plurality of mashup candidate audio snippets that harmonically match the audio snippet;
receiving, via the GUI presented on the user computing device, a selection of one of the subset of the plurality of mashup candidate audio snippets; and
generating a mashup audio snippet based on the audio snippet and the selected one of the subset of the plurality of mashup candidate audio snippets, the mashup audio snippet including at least one stem from the audio snippet and at least one stem from the selected one of the subset of the plurality of mashup candidate audio snippets.

2. The computer-implemented method of claim 1, wherein the mashup catalog includes, for each of the plurality of audio files: (i) one or more stems separated from the audio file; and (ii) metadata indicating a tempo and a key of the audio file, and annotations for chord type, beat/downbeat, and song structure.

3. The computer-implemented method of claim 2, further comprising:
receiving, via the GUI presented on the user computing device, a selection representing a number of stems of the selected one of the subset of the plurality of mashup candidate audio snippets to be included in the generated mashup audio snippet,
wherein the mashup audio snippet is generated based on the received selection.

4. The computer-implemented method of claim 3, wherein the plurality of stems include vocals, drums, bass, guitars, synths/keys, and effects.

5. The computer-implemented method of claim 2, further comprising:
generating, based on the metadata and for each of the plurality of audio files: (i) the beat marking indicating the metrical information associated with the audio file; (ii) the chord string indicating the harmonic information associated with the audio file.

6. The computer-implemented method of claim 5, further comprising:
determining, based on the annotations for the song structure in the metadata, for a given beat of a given audio file in the mashup catalog that is associated with a change in the song structure, a ratio between a portion of the given beat before the change to a portion of the given beat after the change; and
assigning the section number to the given beat based on the determined ratio.

7. The computer-implemented method of claim 5, further comprising:
determining, based on the annotations for the chord type in the metadata, for a given beat of a given audio file in the mashup catalog that is associated with a change in the chord type, a ratio between a portion of the given beat before the change to a portion of the given beat after the change; and
assigning the chord type to the given beat in the chord string based on the determined ratio.

8. The computer-implemented method of claim 2, further comprising:
identifying from among the plurality of audio files in the mashup catalog, a subset of audio files that are within a threshold tempo distance from a tempo of the audio file and that satisfy a predetermined key relationship with a major key or a minor key of the audio file,
wherein the plurality of mashup candidate audio snippets are identified from the identified subset of audio files.

9. The computer-implemented method of claim 8, wherein identifying the subset of audio files that satisfy the predetermined key relationship comprises:
determining, based on the metadata, whether the audio file is in the major key or in the minor key;
in response to determining that the audio file is in the major key, ignoring audio files in the mashup catalog that are in the minor key except for audio files that are in a relative minor key to a key of the audio file; and
in response to determining that the audio file is in the minor key, ignoring audio files in the mashup catalog that are in the major key except for audio files that are in a relative major key to the key of the audio file.

10. The computer-implemented method of claim 1, wherein identifying the subset of the plurality of mashup candidate audio snippets comprises:
determining for each of the plurality of mashup candidate audio snippets, whether chord types of at least half of the beats in the chord string of the mashup candidate audio snippet match or are related to chord types of respective beats at same positions in the chord string of the audio snippet.

11. The computer-implemented method of claim 1, further comprising:
determining, based on the comparing of the chord string of the audio snippet with the respective chord strings of each of the plurality of mashup candidate audio snippets, that none of the plurality of mashup candidate audio snippets harmonically match the audio snippet; and
performing a first pitch shift for each of the plurality of mashup candidate audio snippets to identify a subset of the plurality of mashup candidate audio snippets after the first pitch shift that harmonically match the audio snippet.

12. The computer-implemented method of claim 11, further comprising:
determining, based on a comparison of the chord string of the audio snippet with respective chord strings of each of the plurality of mashup candidate audio snippets after the first pitch shift, that none of the plurality of mashup candidate audio snippets after the first pitch shift harmonically match the audio snippet; and
performing a second pitch shift for each of the plurality of mashup candidate audio snippets to identify a subset of the plurality of mashup candidate audio snippets after the second pitch shift that harmonically match the audio snippet, wherein the second pitch shift is by a greater number of semitones than the first pitch shift.

13. A non-transitory computer-readable storage medium storing executable instructions that, when executed by a hardware processor of a mashup platform, cause the hardware processor to perform steps comprising:
receiving, via a graphical user interface (GUI) presented on a user computing device, a selection of an audio snippet, the selection indicating an identifier of an audio file, a start time, and an end time, wherein the audio file is from among a plurality of audio files in a mashup catalog;
accessing a beat marking associated with the audio file, the beat marking indicating metrical information associated with the audio file, the metrical information including for each of a plurality of beats of the audio file, a beat number, a bar number, and a section number;
accessing a chord string associated with the audio file, the chord string indicating harmonic information associated with the audio file, the harmonic information including a chord type for each of the plurality of beats of the audio file;
identifying a metrical signature and a chord string of the audio snippet, the metrical signature including a beat number and a bar number associated with a beat of the audio file corresponding to the start time, and the chord string including the chord type for each beat of the audio snippet;
identifying, from among the plurality of audio files, a plurality of mashup candidate audio snippets that match the metrical signature of the audio snippet and that have a beat length that matches a beat length of the audio snippet;
comparing the chord string of the audio snippet with respective chord strings of each of the plurality of mashup candidate audio snippets to identify a subset of the plurality of mashup candidate audio snippets that harmonically match the audio snippet;
receiving, via the GUI presented on the user computing device, a selection of one of the subset of the plurality of mashup candidate audio snippets; and
generating a mashup audio snippet based on the audio snippet and the selected one of the subset of the plurality of mashup candidate audio snippets, the mashup audio snippet including at least one stem from the audio snippet and at least one stem from the selected one of the subset of the plurality of mashup candidate audio snippets.

14. The non-transitory computer-readable storage medium of claim 13, wherein the mashup catalog includes, for each of the plurality of audio files: (i) one or more stems separated from the audio file; and (ii) metadata indicating a tempo and a key of the audio file, and annotations for chord type, beat/downbeat, and song structure.

15. The non-transitory computer-readable storage medium of claim 14, wherein the instructions further cause the hardware processor to perform a step comprising:
receiving, via the GUI presented on the user computing device, a selection representing a number of stems of the selected one of the subset of the plurality of mashup candidate audio snippets to be included in the generated mashup audio snippet, wherein the mashup audio snippet is generated based on the received selection.

16. The non-transitory computer-readable storage medium of claim 15, wherein the plurality of stems include vocals, drums, bass, guitars, synths/keys, and effects.

17. The non-transitory computer-readable storage medium of claim 14, wherein the instructions further cause the hardware processor to perform a step comprising:
generating, based on the metadata and for each of the plurality of audio files: (i) the beat marking indicating the metrical information associated with the audio file; (ii) the chord string indicating the harmonic information associated with the audio file.

18. The non-transitory computer-readable storage medium of claim 17, wherein the instructions further cause the hardware processor to perform steps comprising:
determining, based on the annotations for the song structure in the metadata, for a given beat of a given audio file in the mashup catalog that is associated with a change in the song structure, a ratio between a portion of the given beat before the change to a portion of the given beat after the change; and
assigning the section number to the given beat based on the determined ratio.

19. The non-transitory computer-readable storage medium of claim 17, wherein the instructions further cause the hardware processor to perform steps comprising:
determining, based on the annotations for the chord type in the metadata, for a given beat of a given audio file in the mashup catalog that is associated with a change in the chord type, a ratio between a portion of the given beat before the change to a portion of the given beat after the change; and
assigning the chord type to the given beat in the chord string based on the determined ratio.

20. A mashup system, comprising:
a hardware processor; and
a non-transitory computer-readable storage medium storing executable instructions that, when executed by the hardware processor, cause the hardware processor to perform steps comprising:
receiving, via a graphical user interface (GUI) presented on a user computing device, a selection of an audio snippet, the selection indicating an identifier of an audio file, a start time, and an end time, wherein the audio file is from among a plurality of audio files in a mashup catalog;
accessing a beat marking associated with the audio file, the beat marking indicating metrical information associated with the audio file, the metrical information including for each of a plurality of beats of the audio file, a beat number, a bar number, and a section number;
accessing a chord string associated with the audio file, the chord string indicating harmonic information associated with the audio file, the harmonic information including a chord type for each of the plurality of beats of the audio file;
identifying a metrical signature and a chord string of the audio snippet, the metrical signature including a beat number and a bar number associated with a beat of the audio file corresponding to the start time, and the chord string including the chord type for each beat of the audio snippet;
identifying, from among the plurality of audio files, a plurality of mashup candidate audio snippets that match the metrical signature of the audio snippet and that have a beat length that matches a beat length of the audio snippet;
comparing the chord string of the audio snippet with respective chord strings of each of the plurality of mashup candidate audio snippets to identify a subset of the plurality of mashup candidate audio snippets that harmonically match the audio snippet;
receiving, via the GUI presented on the user computing device, a selection of one of the subset of the plurality of mashup candidate audio snippets; and
generating a mashup audio snippet based on the audio snippet and the selected one of the subset of the plurality of mashup candidate audio snippets, the mashup audio snippet including at least one stem from the audio snippet and at least one stem from the selected one of the subset of the plurality of mashup candidate audio snippets.
